(19) United States
(12) Patent Application Publication
(10) Pub. No.: US 2018/0327241 A1
(43) Pub. Date: Nov. 15, 2018

(54) DEVICE FOR EJECTING A CORK FROM A CORKSCREW AND CORKSCREW PROVIDED WITH SUCH AN EJECTION DEVICE

(71) Applicant: PSP, Quingey (FR)

(72) Inventor: Nicolas BROUILLAC, Saint Vit (FR)

(21) Appl. No.: 15/776,869

(22) PCT Filed: Oct. 27, 2016
(86) PCT No.: PCT/FR16/52803

§ 371 Date: May 17, 2018

(30) Foreign Application Priority Data
Nov. 19, 2015 (FR) 15 61148

(51) Int. Cl. B67B 7/04

(52) U.S. Cl. CPC B67B 7/0441

(57) ABSTRACT

The device for ejecting a cork from a corkscrew includes a body in which a spiral is received. There is a tubular cradle housed in a housing to accommodate the spiral and a cork screwed in the spiral. The cradle is formed by a stationary sleeve secured to the body and a sliding sleeve, translatable relative to the stationary sleeve, between a position in which it is completely nested in the stationary sleeve and a position in which it is at least partially removed from the stationary sleeve. Each sleeve has an upper end and a lower end, and the sliding sleeve has a mechanism to exert a force on the cork oriented toward the lower end of the stationary sleeve.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a device for ejecting a cork from a corkscrew of the type including a body traversed by a tubular passage defining a housing in which a spiral is received that is able to be rotated around the longitudinal axis of said body using a gripping element connected to one of its ends and extending outside said body.

The invention also relates to a corkscrew, of the type including a body traversed by a tubular passage defining a housing in which a spiral is received, equipped with such a device for ejecting a cork.

### 2. Description of Related Art Including Information Disclosed Under 37 CFR 1.97 and 37 CFR 1.98

Traditionally, to uncork a bottle using such a corkscrew, a user first fits the body of the latter on the neck of the bottle. He next screws the spiral into the cork closing the bottle, then exerts a rotational force on the latter translating the cork through the effect of a helical spiral, making it possible to remove it from the bottle and cause it to abut at the bottom of the housing delimited by the body of the corkscrew. The user next removes the body of the corkscrew from the neck of the bottle, and unscrews the spiral. Ideally, the freed cork should then fall from the body of the corkscrew by gravity to be able to be recovered, for example in the user's hand placed below the corkscrew, and next allow the corkscrew to be used again.

In practice, it is frequently observed that many corks, in particular due to their slight expansion once removed from a bottle, remain jammed in the housing inwardly delimited by the body of the corkscrew and the dimensions of which are generally adjusted to those of the cork. When this occurs, the user obviously has no other solution than to insert his fingers into the body of the corkscrew in order to grasp the cork, and manually free it from the housing, or to push the cork by unscrewing half of the spiral from the corkscrew. Such an approach is not only tedious, but also has the unacceptable drawback of causing slight injuries in some cases to the user's fingers, compressed in the small volume of the body of the corkscrew to extricate the cork therefrom. Lastly, a cork, in particular when it is made from a brittle material such as cork itself, may be damaged by the somewhat brutal handling that it inevitably experiences during its forced removal. This may then prevent it from being reused later to reclose a partially consumed bottle, and force the user to obtain a spare cork, which may in some cases be of lesser quality.

### BRIEF SUMMARY OF THE INVENTION

The present invention aims to offset these drawbacks proposing a solution allowing a user to remove, easily and successfully with each attempt, a cork held in the body of a corkscrew without having to insert his fingers therein, or having to push the cork with the corkscrew, therefore made safer, and while preserving the structural integrity of the cork in question.

To that end, the present invention relates to a device for ejecting a cork from a corkscrew of the type indicated in the preamble, characterized in that it includes a tubular cradle able to be housed in the housing of a corkscrew and to accommodate said spiral and a cork screwed on the spiral, said cradle being formed by a stationary sleeve intended to be secured to said body of the corkscrew and a sliding sleeve, translatable relative to the stationary sleeve, between a position in which it is completely nested in the stationary sleeve and a position in which it is at least partially removed from said stationary sleeve, said stationary and sliding sleeves having an upper end and a lower end considered in a vertical position of the ejection device, and said sliding sleeve including means able to exert, on a cork retained in said corkscrew, a force oriented toward the lower end of the stationary sleeve, when it is brought toward its position in which it is at least partially removed from said stationary sleeve.

The invention also relates to a corkscrew including a hollow body arranging a housing in which a spiral is received able to be rotated around the longitudinal axis of said body using a gripping element connected to one of its ends and extending outside said body, said housing being able to accommodate a cork screwed on the spiral and having, near the free end of the spiral, at least a portion with a circular section able to be fitted on the neck of a bottle, characterized in that it includes a device for ejecting a cork as defined above.

### BRIEF DESCRIPTION OF THE SEVERAL VIEWS OF THE DRAWINGS

Other features and advantages of the invention will emerge from the following detailed description relative to one embodiment of the ejection device given solely for information and non-limitingly.

The understanding of this description will be facilitated in reference to the attached drawings.

FIG. 1 shows a perspective view of a corkscrew according to the invention.

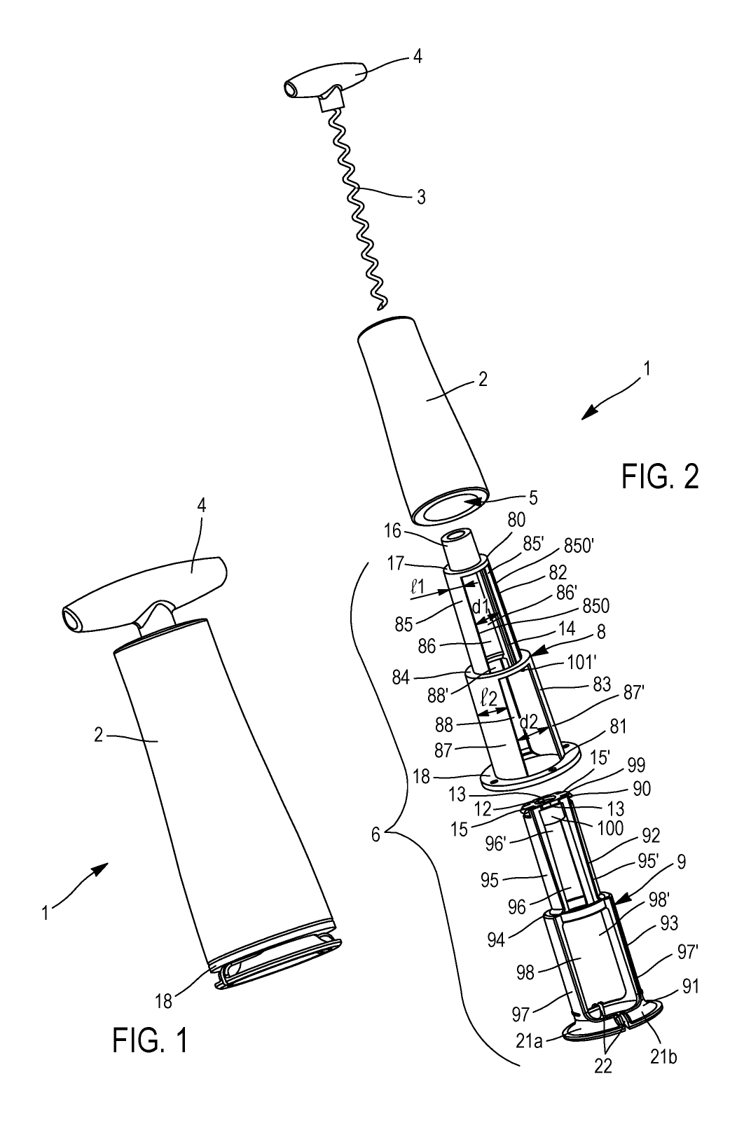

FIG. 2 shows a perspective view of all of the component parts of the corkscrew of FIG. 1.

FIGS. 3 to 8 show sectional views of the corkscrew of FIG. 1 during different steps of its use to uncork a bottle.

### DETAILED DESCRIPTION OF THE INVENTION

In the alternative embodiment illustrated in the figures, the corkscrew 1 according to the invention includes a generally tubular body 2, the outer wall of which is solid, and which can be made from a material such as in particular wood, metal, plastic, a composite material, or any other equivalent material that is both solid and aesthetically pleasing. Traditionally, the body 2 inwardly delimits a housing 5 able to house a spiral 3 intended to be rotated around the longitudinal axis of the body 2 by a user manipulating a gripping element, such as a handle 4 emerging from the body 2 and connected to one end of the spiral 3.

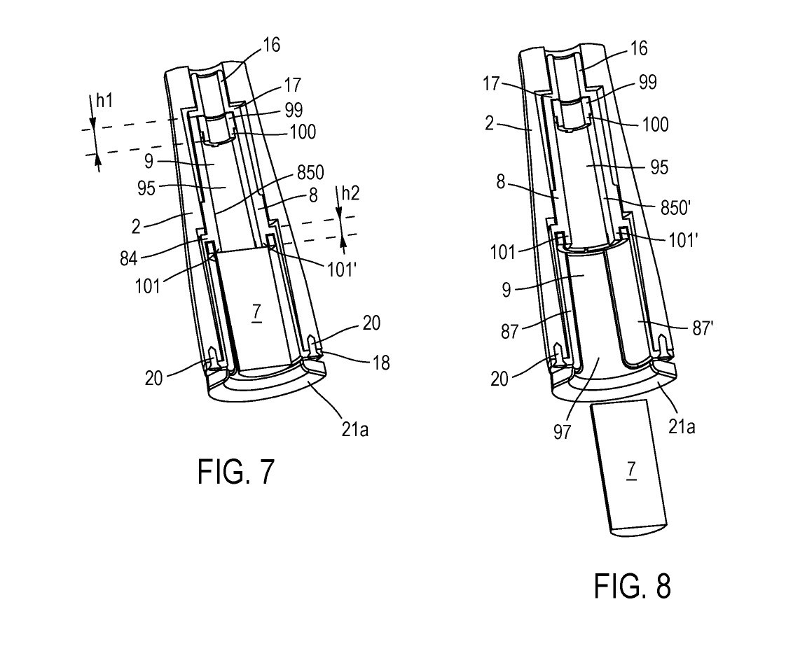

According to the invention, the corkscrew 1 is also equipped with a device for ejecting a cork 7 remaining housed in the housing 5 after it has been removed from a bottle 11. The ejection device includes a tubular cradle 6. As shown in FIGS. 3 to 8, the housing 5 and the cradle 6 have a complementary shape allowing them to be fitted. The cradle 6 is also configured so as to be able to accommodate the spiral 3 and a cork 7 screwed in the spiral 3. The cradle 6 can for example be made from a material such as a plastic, composite material, ceramic material, metal or any other equivalent material.

In the illustrated alternative embodiment, the cradle 6 is formed by a stationary sleeve 8 intended to be secured to the body 2 of the corkscrew 1 and a sliding sleeve 9, translatable relative to the stationary sleeve 8, between a position in which it is completely nested and housed in the stationary sleeve 8 (cf. for example FIG. 5) and a position in which it is at least partially removed from the stationary sleeve 8 (cf. FIG. 6).

The stationary 8 and sliding 9 sleeves have an upper end 80, 90 and a lower end 81, 91 considering a vertical position of the cradle 6. They each have a first segment 82, 92, the section of which is provided able to accommodate, in a tight manner, a cork 7 screwed on the spiral 3 and a second segment 83, 93, with a section larger than that of the first segment 82, 92 able to be nested on the neck 10 of a container closed by the cork 7, such as a bottle 11. Each of the stationary 8 and sliding 9 sleeves thus has a shoulder 84, 94 formed between its first segment 82, 92 and its second segment 83, 93.

In the illustrated alternative embodiment, the peripheral wall of the stationary sleeve 8 includes two strips of material 85, 85′, the outer faces of which are curved, while the inner faces 850, 850′ are planar. These two strips of material 85, 85′ are symmetrical relative to the axis of the stationary sleeve 8 and extend over its first segment 82 between its upper end 80 and its shoulder 84. Their inner faces 850, 850′ are spaced apart by a distance d1 allowing the gripping of a cork 7. Furthermore, the strips of material 85, 85′ extend below the shoulder 84 and thus define two fins 101, 101′ with tight h2 extending at the upper end of the second segment 83 of the stationary sleeve 8. Furthermore, the strips of material 85, 85′ delimit two longitudinal slits 86, 86′ also extending between the upper end 80 and the shoulder 84 of the first segment 82.

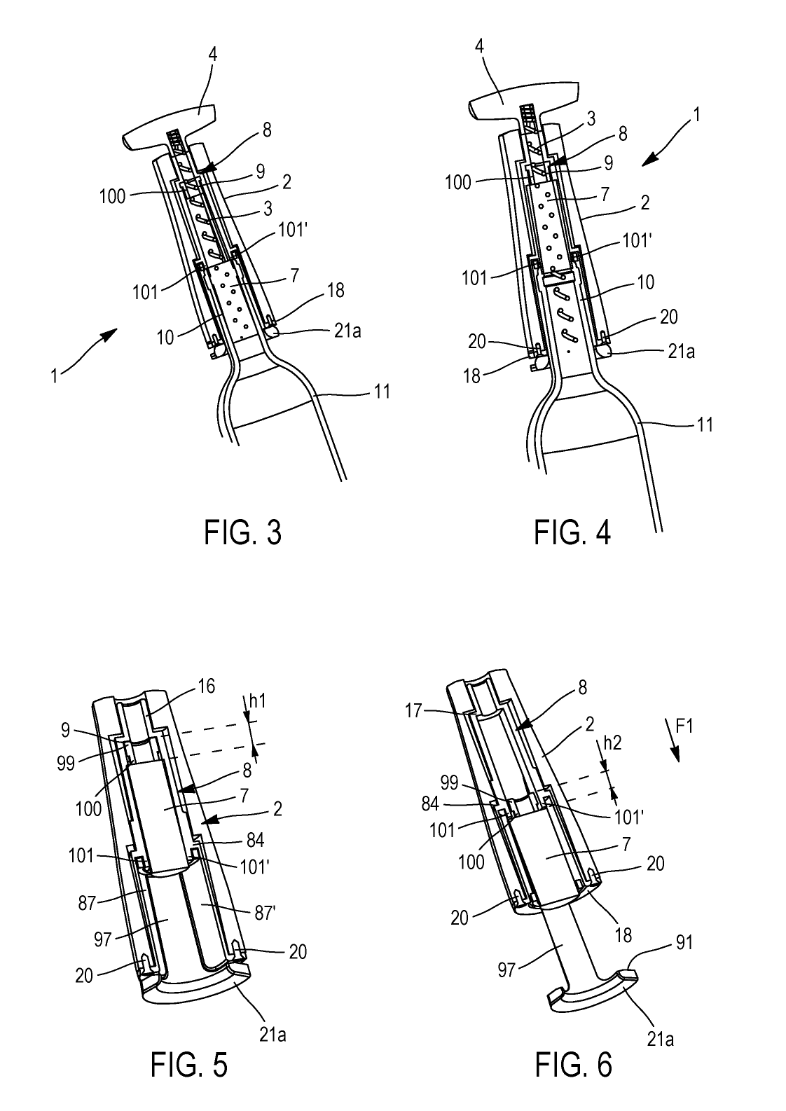

The peripheral wall of the stationary sleeve 8 further includes two strips of material 87, 87′ that are symmetrical relative to the axis of the stationary sleeve 8 and extending over its second segment 83 between its shoulder 84 and its lower end 81, while delimiting two longitudinal slits 88, 88′ (cf. FIG. 2). The material strips 87, 87′ of the second segment 83 of the stationary sleeve 8 have curved inner faces, spaced apart by a diameter d2 and having a width 12 greater than the width 11 of the strips of material 85, 85′ of the first segment 82, and chosen so as to impart an identical width to all of the longitudinal slits 86, 86′, 88, 88′ of the stationary sleeve 8.

The sliding sleeve 9 has a peripheral wall complementary to that of the stationary sleeve 8. Indeed, it includes, on each of its first and second segments 92, 93, two strips of material 95, 95′, 97, 97′ respectively extending between its upper end 90 and the shoulder 94, and between the latter and its lower end 91. These strips of material 95, 95′, 97, 97′ are complementary to the longitudinal slits 86, 86′, 88, 88′ of the stationary sleeve 8 and thus delimit, on the sliding sleeve 9, longitudinal slits 96, 96′, 98, 98′ complementary to the strips of material 85, 85′, 87, 87′ of the stationary sleeve 8.

It should also be noted that the strips of material 85, 85′, 87, 87′, 95, 95′, 97, 97′ include rectilinear longitudinal edges.

Owing to such a structure, the two stationary 8 and sliding 9 sleeves can be nested, their respective strips of material 85, 85′, 87, 87′, 95, 95′, 97, 97′ being inserted in their respective longitudinal slits 86, 86′, 88, 88′, 96, 96′, 98, 98′ and consequently being in contact with one another at their respective straight longitudinal edges. The latter define, as will be described in more detail below, first means for guiding the translation of the sliding sleeve 9 relative to the stationary sleeve 8. It should be noted that the sliding sleeve 9 is blocked in rotation relative to the stationary sleeve 8 owing to the contact between the respective longitudinal edges of the strips of material 85, 85′, 87, 87′, 95, 95′, 97, 97′ irrespective of its position relative to the stationary sleeve 8.

According to the invention, the upper end 90 of the sliding sleeve 9 is also closed by a membrane seal 99 having a central orifice 12 able to allow the spiral 3 to pass when the cradle 6 is nested in the body 2 of the corkscrew 1.

In reference to FIG. 2, the edge of the membrane seal 99 of the sliding sleeve 9 includes two opposite slots 13, centered in the extension of each of the longitudinal slits 96, 96′. They are provided able to cooperate, when the two sleeves 8, 9 are nested, with two opposite longitudinal ribs 14, centered on the planer inner face 850, 850′ of each of the complementary strips 85, 85′ of the peripheral wall of the first segment 82 of the stationary sleeve 8, intended to be received in said slit 96, 96′. The assembly formed by the two slots 13 of the sliding sleeve 9 and the two longitudinal ribs 14 of the stationary sleeve 8 defines second means for guiding the translation of the sliding sleeve 9 relative to the stationary sleeve 8.

It should be noted that the ribs 14 also make it possible to ensure rotational blocking of a cork 7, housed in the part of the corkscrew 1 formed by the first segments 82, 92 of the stationary 8 and sliding 9 sleeves, after it is removed from a bottle 11, during the unscrewing of the spiral 3. Of course, other means for blocking the rotation of the cork 7 can be considered, for example a pair of ribs formed on the inner face of each of the strips of material 95, 95′ of the sliding sleeve 9, or any other equivalent means.

Furthermore, the membrane seal 99 also includes two opposite tabs 15, 15′ extending in its plane, on its edge, in the extension of the two strips of material 95, 95′ of the first segment 92 of the sliding sleeve 9. These two tabs 15, 15′ bear on the shoulder 84 of the stationary sleeve 8 when the sliding sleeve 9 is brought toward its position in which it is at least partially removed from the stationary sleeve 8, so as to prevent it from being completely removed from the stationary sleeve 8. Furthermore, each of the tabs 15, 15′ has two opposite side edges that extend abutting against the longitudinal edges of the strips of material 85, 85′ of the stationary sleeve 8, which also prevents any rotation of the sliding sleeve 9 relative to the stationary sleeve 8. Lastly, the lower face of the membrane seal 99 is extended by a tubular stop 100, centered on its central orifice 12, and having a height h1 identical to the height h2 of the fins 101, 101′.

The stationary sleeve 8 further includes a third segment 16 extending in the extension of its first segment 82 and having an outer diameter smaller than the outer diameter of the first segment 82. Thus, the stationary sleeve 8 includes a second shoulder 17 extending between its first segment 82 and its third segment 16.

Furthermore, the lower end 81 of the stationary sleeve 8 includes a flange 18 on which a plurality of holes 19 extend, regularly distributed and allowing the fastening of the stationary sleeve 8 to the body 2 of the corkscrew 1, for example using screws 20 inserted into the holes 19 and screwed in the body 2. Of course, other equivalent fastening means may be considered.

The lower end 91 of the sliding sleeve 9 is extended by a flange 21 extending in front of the flange 18 of the stationary sleeve 8 when the two sleeves are nested. This flange 21 provides the gripping function allowing a user to handle the ejection device according to the invention more easily. In the illustrated alternative embodiment, the gripping flange 21 includes two transverse slits 22 dividing it into two half-flanges 21a, 21 extending in the extension of the strips of material 97, 97′ of the second segment 93 of the sliding sleeve 9. This makes it possible to bring these two strips of material 97, 97′ closer together to facilitate the sliding of the sliding sleeve 9 relative to the stationary sleeve 8, as will be explained below.

In practice, and in reference to FIGS. 3 to 8, during the use of the corkscrew 1 according to the invention, equipped with the ejection device described above, to uncork a bottle 11, the user first makes sure that the sliding sleeve 9 is completely nested in the stationary sleeve 8 and that it is consequently retracted in the latter. He next nests the corkscrew 1 on the neck 10 of the bottle 11, closed by the cork 7. The assembly formed by the respective second segments 83, 93 of the stationary 8 and sliding 9 sleeves is then placed around the neck 10 (cf. FIG. 3). The spiral 3 is next screwed in the stopper 7 and a pulling force exerted on the latter makes it possible to bring it gradually into the assembly formed by the respective first segments 82, 92 of the stationary 8 and sliding 9 sleeves until it is stopped by the annular stop 100 of the membrane seal 99 of the sliding sleeve 9 (cf. FIG. 4). The distance d1 comprised between the planar inner faces 850, 850′ of the strips of material 85, 85′ of the first segment 82 of the stationary sleeve being chosen so as to obtain a tight adjustment of the cork 7 received in the cradle 6, said cork 7 remains in the compressed state in which it was found while it was housed in the bottle 11. The latter now being uncorked, the user removes the corkscrew 1 from the neck 10, the cork 7 remaining screwed on the spiral 3 and blocked in the body 2 of the corkscrew 1.

In order to allow the corkscrew 1 to be used again, and consequently to free the cork 7 blocked in the cradle 6, the user unscrews the spiral 3 (cf. FIG. 5). He next grasps the two half-flanges 21a, 21b bordering the lower end 91 of the sliding sleeve 9. This results in causing the strips of material 97, 97′ of the sliding sleeve 9 to tighten, and makes the sliding of the latter part easier relative to the stationary sleeve 8. The sliding sleeve 9, guided in translation by the first and second translational guiding means described above, is gradually removed from the body 2 of the corkscrew 1. During its movement, the sliding sleeve 9 takes the cork 7 with it, on which the tubular stop 100 of the membrane seal 99 exerts a force F1 oriented toward the lower end 80 of the stationary sleeve 8. When the tabs 15 of the membrane seal 99 abut on the shoulder 84 of the stationary sleeve 8, the first segment 92 of the sliding sleeve 9, still containing the cork 7, is housed inside the second segment 83 of the stationary sleeve 8 (cf. FIG. 6). The cork 7 is then no longer constrained between the strips of material 85, 85′, 95, 95′ of the stationary 8 and sliding 9 sleeves, but can expand at least partially between the strips of material 95, 95′ of the sliding sleeve 9, and the strips of material 87, 87′ of the stationary sleeve 8. Owing to the presence of the tubular stop 100 having a height h1 equivalent to that h2 of the fins 101, 101′, the upper face of the cork 7 is located just below the lower end of said fins 101, 101′. Then, due to its at least partial expansion, the edge of the upper face of the cork 7 abuts against the lower end of the fins 101, 101′ of the stationary sleeve 8. Consequently, when the user pushes the sliding sleeve 9 back so as to re-nest it in the stationary sleeve 8, the cork 7 is no longer taken with it, but remains in the assembly formed by the respective second segments 83, 93 of the stationary 8 and sliding 8 sleeves, retained by its fins 101, 101′ (cf. FIG. 7). The inner diameter d2 of this assembly being larger than that of the cork 7, the latter now falls by gravity and can be recovered easily by the user (cf. FIG. 8).

It should be noted that the ejection device according to the invention can be designed as a universal module suitable for adapting to a large number of corkscrews having different shapes and characteristics.

1. A device for ejecting a cork from a corkscrew having a body with a tubular through passage defining a housing and a spiral rotatable around a longitudinal axis of said body using a gripping element connected to one end of said body and extending outside said body, the device comprising:
a tubular cradle housed in the housing of a corkscrew and to accommodate said spiral and a cork screwed on the spiral, said tubular cradle being comprised of a stationary sleeve secured to said body and a sliding sleeve being translatable relative to the stationary sleeve between a position completely nested in stationary sleeve and a position at least partially removed from said stationary sleeve each sleeve having an upper end and a lower end considering a vertical position of the ejection device; and
means to exert a force on the cork oriented toward a lower end of the stationary sleeve, when brought toward its position in which it is at least partially removed from said stationary sleeve.

2. The device for ejecting, according to claim 1, wherein an upper end of the sliding sleeve is closed by a membrane seal having a central orifice able to allow the spiral to pass.

3. The device for ejecting, according to claim 1, wherein said stationary sleeve comprises means for blocking the rotation of the sliding sleeve, and wherein said sliding sleeves comprises said means for blocking rotation of said sliding sleeve.

4. The device for ejecting, according to claim 1, each sleeve being comprised of a first segment, able to accommodate a cork screwed on the spiral and a second segment, able to be nested on the neck of the bottle, each sleeve having a shoulder formed between its first and second segments.

5. The device for ejecting, according to claim 4, wherein a peripheral wall of each sleeve is comprised of at least one longitudinal slit extending over respective first segment between its upper end and its shoulder and over its second segment between its shoulder and its lower end, wherein a complementary strip of material of the peripheral wall of the first and second segments of the other sleeve is received.

6. The device for ejecting, according to claim 5, further comprising at least one complementary longitudinal slot and rib respectively extending over the edge of the membrane seal of the sliding sleeve in the extension of the slit formed by the latter, and over the inner face of the complementary strip of the peripheral wall of the first segment of the stationary sleeve received in said slit, or vice versa.

7. The device for ejecting, according to claim 4, wherein said sliding sleeve comprises at least one tab extending the outer edge of the membrane seal in the extension of its peripheral wall, said tab bearing on the shoulder formed between the first segment and the second segment of the stationary sleeve when the sliding sleeve is brought toward its position in which it is at least partially removed from said body.

8. The device for ejecting, according to claim 1, wherein said sliding sleeve comprises gripping means able to allow it to be maneuvered by a user.

9. The device for ejecting, according to claim 8, wherein the lower end of the sliding sleeve is extended by a gripping flange.

10. The device for ejecting, according to claim 9, wherein said gripping flange comprises at least one transverse slit extending in the extension of the slit formed by the peripheral wall of the sliding sleeve (9).

11. The device for ejecting, according to claim 1, wherein the lower end of the stationary sleeve comprises a flange able to allow it to be fastened to the body of a corkscrew by appropriate assembly means.

12. The device for ejecting, according to claim 2, wherein the membrane seal of the sliding sleeve comprises an annular stop with height centered on its central orifice and extending below its lower face.

13. The device for ejecting, according to claim 12, wherein said stationary sleeve comprises at least one fin with height equal to height of the annular stop of the sliding sleeve.

14. A corkscrew, comprising:
a hollow body arranging a housing in which a spiral is received able to be rotated around the longitudinal axis of said body using a gripping element connected to one of its ends and extending outside said body, said housing accommodating a cork screwed on the spiral and having, near the free end of the spiral, at least a portion with a circular section fitted on the neck of a bottle; and
a device for ejecting a cork according to claim 1.

15. The corkscrew, according to claim 14, wherein the housing has a shape complementary to a shape of the cradle forming said ejection device.
